(19) United States
(12) Patent Application Publication
(10) Pub. No.: US 2023/0031713 A1
(43) Pub. Date: Feb. 2, 2023

(54) MULCHER

(71) Applicant: MUETHING GmbH & Co. KG, Soest (DE)

(72) Inventors: Michael MUETHING, Winterberg (DE); Klaus BOEGGE, Moehnesee-Guenne (DE)

(73) Assignee: MUETHING GmbH & Co. KG, Soest (DE)

(21) Appl. No.: 17/966,275

(22) Filed: Oct. 14, 2022

Related U.S. Application Data
(63) Continuation of application No. PCT/EP2021/058157, filed on Mar. 29, 2021.

(30) Foreign Application Priority Data
Apr. 17, 2020 (DE) 10 2020 002 342.8

(51) Int. Cl. A01G 3/00; B02C 18/18

(52) U.S. Cl. CPC A01G 3/002; B02C 18/18; B02C 2018/188

(57) ABSTRACT

To improve the comminution of the plant material cut off by a mulching device, a mulching device is provided comprising a rotor which can be rotated in a direction of rotation by means of a shaft and has movable blades, and comprising, with respect to the movable blades, counter-cutting elements that are fixed to the device, that cutting edges of the counter-cutting elements directed opposite to the direction of rotation have a corrugated shape, wherein, in their direction of extension, in particular the counter-cutting elements have at least two convex portions with one concave portion arranged therebetween. The cutting unit can be formed in one piece without any connection.

This nonprovisional application is a continuation of International Application No. PCT/EP2021/058157, which was filed on Mar. 29, 2021, and which claims priority to German Patent Application No. 10 2020 002 342.8, which was filed in Germany on Apr. 17, 2020, and which are both herein incorporated by reference.

### BACKGROUND OF THE INVENTION

### Field of the Invention

The present invention relates to a mulching device, comprising a rotor which can be rotated in a direction of rotation by means of a shaft and has movable blades, and comprising counter-cutting elements of a cutting unit that are fixed to the device and face the movable blades.

### Description of the Background Art

A generic mulching device is known from EP 1 782 680 B1, which is incorporated herein by reference. Such a generic mulching device, as well as the mulching device according to the invention, is used for comminuting plant material, in particular in the form of green crop material and/or small-diameter wood lying on the ground. In the mulching mode, i.e., during and for the purpose of mulching, the mulching device moves over a soil having, in particular, plants and/or plant stumps, whether in a self-propelled manner or pulled or pushed by a vehicle (tractor).

When placed on a horizontal plane, the known mulching device—like the mulching device according to the invention—has a rotor having a horizontal working shaft, outwardly extending rotatable (working) blades being arranged on the outer circumference of the rotor so as to be distributed over the circumference. Furthermore, counter-cutting elements that are fixed to the device are provided, in particular on a housing that overlaps the upper region of the rotor. The radially inner end or the free tip of the counter-cutting element lies outside the contour of the rotatable working blade or the outer ends thereof. Furthermore, the counter-cutting elements have cutting edges which are directed opposite to the rotary direction of the working shaft and have a finite angle relative to the extension of the radius extending from the working shaft in the rotary direction of the working shaft. In particular, said cutting edges of the counter-cutting elements, which edges are directed opposite to the rotary direction, are of substantially concave design. The counter-cutting elements are arranged on a beam. The counter-cutting elements have a rectangular cross section, i.e., a cutting surface directed opposite to the rotor, which cutting surface is formed at right angles to faces extending from said cutting surface in parallel with one another and perpendicularly to the shaft, as is in principle conventional with counter-cutting elements of this type. Counter-cutting elements are connected to the beam by welding; the latter is bolted to the device.

By means of a mulching device designed with counter-cutting elements of this type, as is the subject matter of EP 1 782 680 B1 and as was further developed in other respects according to EP 2 997 802 B1 and also EP 3 449 710 A1, which corresponds to US 2019/0059216, and which are all herein incorporated by reference at least with respect to the design of a generic mulching device, good working results are achieved, i.e. not only an excellent cutting pattern of the expanded area, but also a very good comminution of the cut plant material which, according to the characteristics of the mulching process, is brought back to the worked area, said cut plant material being comminuted in such a way that it falls between the remaining stalks of the plant material and thus does not affect the surface appearance.

Nevertheless, an improvement of every working device is in principle striven for, in particular an improvement of the generic mulching device to the effect that the working result is improved even in the case of unfavorable working conditions and/or working surfaces, in particular to the effect that the plant material is even further comminuted compared to the prior art. Known counter-cutting elements are produced using known connecting or joining methods, such as in particular integrally bonded individual parts, if these also cannot be separated without being destroyed. The shaping of counter-cutting elements of this type is limited.

### SUMMARY OF THE INVENTION

It is therefore an object of the present invention to further develop a mulcher/mulching device such that an improved working result is achieved with further comminuted plant material and more comprehensive design options are provided.

According to an exemplary embodiment of the invention, the stated object is achieved in a generic mulching device in that cutting edges of the counter-cutting elements, which cutting edges run substantially perpendicularly to the axis of rotation and are directed opposite to the direction of rotation, have a corrugated shape in their direction of extension.

Due to the corrugated shape of the cutting edges of the counter-cutting elements, the length of the cutting edges is increased compared to the prior art, which means that a greater length is available for comminuting the plant material and therefore more extensive and better comminuting is achieved.

It is provided that, in their direction of extension, the cutting edges of the counter-cutting elements can have at least two convex portions with one concave portion arranged therebetween. In principle, two convex portions can be provided with a concave portion of the cutting edges arranged therebetween. However, the corrugated shape can also be further configured such that more than two convex portions, for example three convex portions with a total of two concave portions therebetween, are provided, or more convex and concave portions are correspondingly provided in each case.

The working result of a mulching device with cutting edges of the counter-cutting elements designed in this way can be further improved in that, in contrast to the prior art, where the cutting elements have a rectangular cross section, provision is made for the cutting edges to be designed to be triangular in cross section, the cutting edges in particular running into a sharp edge in the transverse direction relative to the longitudinal extension of the counter-cutting elements, and the faces forming the cutting edge most preferably enclosing an angle of less than 90°, preferably less than 60°. As a result, the comminution is effected on an acute-angled cutting edge of the counter-cutting elements, which further improves the comminution result.

The counter-cutting elements can have a thickening at their free end, with the thickening in particular being designed to be at least partially spherical. This creates a certain resistance to the material to be cut, which is conveyed by the rotor and the movable cutting blades thereof against the counter-cutting elements, at the inner end of said counter-cutting elements, whereby the stalks of the material to be cut are stopped and pressed more strongly against the cutting edge of the counter-cutting elements, which also contributes to improving the comminution. The above embodiments of the counter-cutting elements according to the invention can be achieved in an optimal manner by one-piece designs, in particular in that the counter-cutting element and thickening are formed in one piece.

A mulching device having counter-cutting elements facing a tube provided with blades or flails is further characterized in that the cutting unit is formed in one piece without any connection.

The counter-cutting elements are therefore made in one piece from a single material and are not formed of individual parts that are connected by a connection, such as a bonded, non-positive, or positive connection, and cannot be separated without being destroyed. The cutting unit is therefore preferably a one-piece cast part or else a part which is likewise in one-piece and generatively or additively manufactured. The material is preferably steel, such as high quality steel, in particular stainless steel.

Then, after thickening, the unit formed of counter-cutting elements is also formed in one piece without any connection, preferably as a forged part or a generatively or additively manufactured part.

The same applies if the counter-cutting elements are formed in one piece with the crossbeam and if a plurality of counter-cutting elements are formed on a crossbeam and form a cutting unit therewith. In this case, it is particularly preferred that the entire cutting unit is a connection-free, one-piece part, preferably a forged part or a generatively or additively manufactured part. Further embodiments of the invention according to the invention provide, in a manner known per se, that the radially inner end of the counter-cutting elements is arranged radially outside the outer end of the blades of the rotor and/or that the cutting edges of the counter-cutting elements have a finite angle relative to the extension of the radius extending from the working shaft in the rotary direction of the working shaft.

Additional cutting elements can have different lengths, heights, and/or thicknesses, with at least one, preferably two additional cutting elements having a reduced length and/or height compared to the basic cutting elements being arranged in particular between basic cutting elements. The cutting elements having the greatest directions of extension are referred to as basic cutting elements, between which additional cutting elements with smaller dimensions are arranged. This achieves a better distribution and also collection of all, even small, components of the biomass to be comminuted.

The cutting elements can be aligned at right angles or at a finite angle not equal to 90° relative to an edge of the beam, and/or that the cutting elements extend perpendicularly from the beam or at a finite angle not equal to 90° from said beam, the alignment of the discs of two successive cutting units in particular taking place at different, in particular opposite, angles γ and/or δ. In this way, a denser coverage in space is achieved, also through different alignment of the extension of the angles of the cutting elements to the right and/or left—relative to the longitudinal extension of the beam and/or away from it—without using a higher number of cutting elements. At the same time, the transverse distribution effect at the end of the cutting elements in the rotary direction of the rotor increases, in particular if the above-mentioned thickenings on the free ends of the cutting elements are not arranged directly one behind the other in the rotary direction, i.e., do not overlap but are offset in space. In particular, the inclination of the cutting elements relative to the beam, especially when successive cutting units have differently aligned cutting elements, results in even better coverage of the entire space in the horizontal extension of the cutting units for collecting, processing, and comminuting an even larger part of the biomass.

It can also be provided that, in the region of at least one of the longitudinal edges thereof, the beam can be designed with a reduced thickness compared to the central main region thereof. The beam is thus inclined or—concavely—curved at least in a region of one longitudinal edge or in the region of the two longitudinal edges, so that the mulch material or the biomass does not find any edges as obstacles when it hits the inclined counter-cutting element, and is thus immediately guided slightly upward into the region of the cutting elements in order to flow away effectively, whereby otherwise possible accumulation effects are avoided.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a vertical cross section through a mulching device according to the invention;

FIG. 2 is an enlarged detail view of the mulching device of FIG. 1;

FIG. 3 shows a cutting unit of the mulching device according to the invention;

FIG. 3.1 is a side view of a cutting element according to the invention;

FIG. 3.2 is a detail view of a cutting unit for illustrating the one-piece transition from the crossbeam to a cutting element;

FIG. 3.3 is a cross section through a cutting element of FIG. 3.1.

FIG. 4 shows the embodiment of a cutting unit having additional cutting elements that are arranged between basic cutting elements which extend further;

FIG. 4.1 is an enlarged detail view of FIG. 4;

FIG. 4.2 shows a section through both basic and additional cutting elements of a cutting unit of FIG. 4 parallel to the beam;

FIG. 5 is the perspective view of an embodiment similar to FIG. 4 with two additional cutting elements arranged between two basic cutting elements;

FIG. 6 is the perspective view of a cutting unit similar to that of FIG. 4, but with the cutting elements, in particular the basic cutting elements, in the direction of extension away from the beam relative to the surface thereof having a finite angle γ not equal to 90°;

FIG. 6.1 is a top view of a cutting unit of FIG. 6 with cutting elements inclined to the right in the illustration;

FIG. 6.2 shows a cutting unit similar to that of FIG. 6, but with cutting elements inclined to the left in relation to FIG. 6.1;

FIG. 6.3 is a view of two cutting units of FIGS. 6.1 and 6.2 arranged one behind the other with the inclination of the cutting unit located behind being aligned opposite to the inclination of the cutting elements of the front cutting unit;

FIG. 7 is a perspective view of a cutting unit with cutting elements aligned at a finite angle δ not equal to 90° relative to the direction of extension of the beam;

FIG. 8 is a perspective view of a cutting unit that combines the features of the embodiment of FIGS. 6 and 7, in which the cutting elements are thus aligned both at a finite angle δ not equal to 90° relative to the direction of extension of the beam, and extend away from said beam at a finite angle γ not equal to 90°;

FIG. 8.1 is a top view of a cutting unit according to FIG. 8 with cutting elements directed to the left and inclined to the left;

FIG. 8.2 is a plan view of a cutting unit similar to that of FIG. 8, 8.1, but with cutting elements inclined in the opposite direction to the right;

FIG. 8.3 is a view in the rotary direction of the rotor of cutting units arranged together with one another according to FIGS. 8.1 and 8.2 to show the different spatial alignment of the cutting elements of the two cutting units;

FIG. 9 is a plan view of a cutting unit with a reduced thickness of the beam at the two longitudinal edges compared to the central main region of the beam; and

FIG. 9.1 shows a section through the beam of a cutting unit with a view of a cutting element, the beam having a reduced thickness at the two longitudinal edges thereof compared to the central main region.

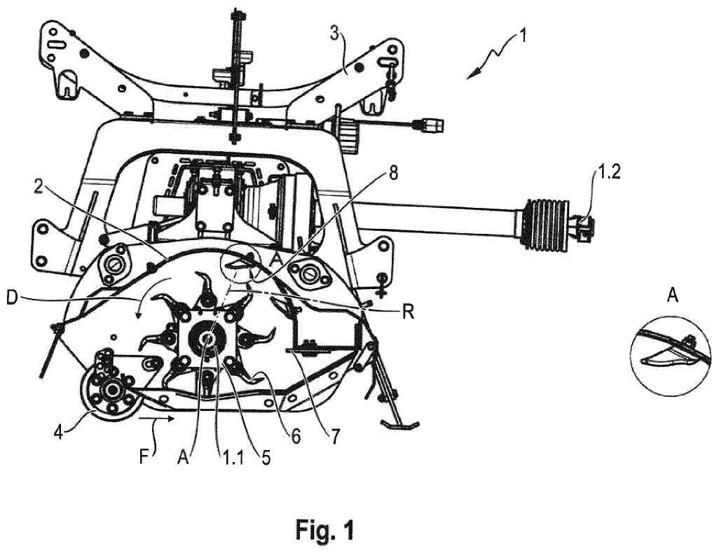

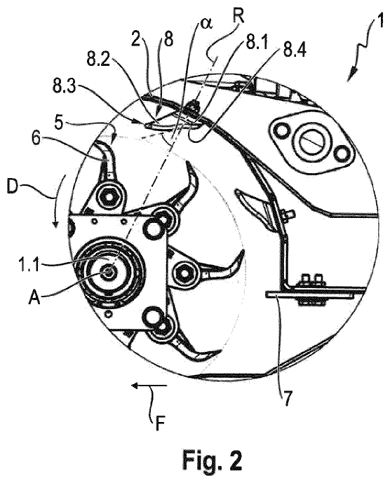

### DETAILED DESCRIPTION

The mulching device 1 according to the invention has a housing 2 that is closed at the top and open at the bottom, which housing can be connected to a vehicle moving the device 1 via a beam 3 in a manner not shown here, for example by means of a three-point linkage or hydraulic system, as is customary and known.

The device is pulled in the direction of travel F by the vehicle. The mulching device 1 is provided with a support roller 4 at the end thereof opposite the beam 3. The mulching device 1 has a rotor 5 with a shaft 1.1 that can be rotated about a horizontal axis of rotation A. The rotor 5 is driven by a vehicle (not shown) via a drive shaft 1.2 and rotates in the direction of rotation D.

The rotor 5 has movable cutting blades 6 in the form of angled flails on the outer circumference thereof.

A displaceable cutting blade 7 is provided in front of the rotor 5 in the direction of travel F, which cutting blade is directed horizontally when the mulching device 1 is arranged on level ground and extends over the entire width of the rotor 5. For a more precise example of the displaceable cutting blade 7, reference is made to EP 2 997 802 B1 and EP 3 449 710 A1, which are incorporated herein by reference.

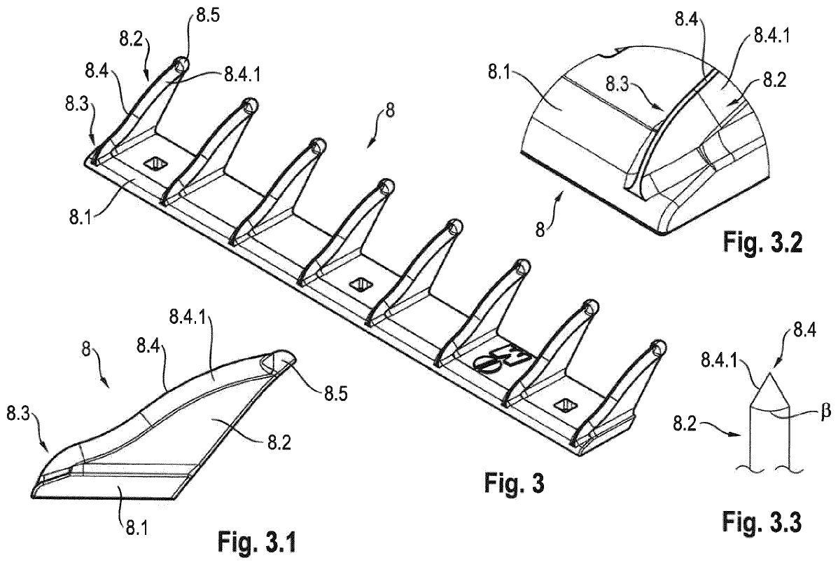

On the housing 2, cutting units 8 fixed to the housing are arranged over the upper circumference of the rotor at a radial distance therefrom. In the embodiment shown, each cutting unit has a beam 8.1 (FIG. 3) which extends parallel to the axis A of the rotor 5 and on which cutting elements 8.2 are formed or arranged. The cutting elements 8.2, including the inner end 8.3 thereof, are arranged radially outside the circumferential contour of the rotor 5 and the blades 6 thereof. The cutting elements 8.2 have in principle a shark fin contour when viewed from the side. At least the cutting edges 8.4 of the cutting elements 8.2 directed opposite to the rotary direction D of the rotor 5 have a finite angle α relative to the extension of the radius extending from the axis A of the rotor, said angle extending from the cutting unit 8 in the rotary direction D of the axis A and being accordingly <90° and preferably below 60°.

Said edge 8.4 has a corrugated shape. In the embodiment shown, the shaft formed of two outer convex portions in the direction of extension of the cutting edge 8.4 and a concave portion arranged therebetween.

While conventional cutting elements and cutting edges have a rectangular cross section, i.e. a narrow side running perpendicularly to the lateral faces and facing the rotatable blades 6, the cutting edge 8.4 is designed to be roof-shaped with a triangular cross section, in which the angle β of the faces 8.4.1 delimiting the cutting edge is less than 90°, preferably less than 60°.

The cutting elements 8.2 have a thickening 8.5 on their outer free tip 8.3, which thickening is in particular designed to be at least partially spherical.

In particular, the cutting elements 8.2 themselves are designed as a forged part together with the thickening 8.5. However, this preferably also applies to the entire cutting unit 8 or a to unit designed in this way that is generatively or additively manufactured.

The cutting elements 8.2 achieves improved comminution of the material to be cut, first of all because, due to the corrugated or S-shaped design of the cutting edge 8.4, the latter, compared to a merely straight or stretched or only unidirectionally (convexly) curved cutting element, is given a greater length with the same total distance of the tip 8.3 from the wall of the housing 2, and thus a greater length is available for cutting. This is further supported by the fact that the cutting element is not designed as a rectangle in cross section, but rather the cutting edge is designed in the shape of a roof, as shown. Furthermore, the thickening 8.5 on the free tip 8.3 of the cutting element 8.2 contributes to the support, whereby a certain stopping force is exerted on the material to be cut, which material is pressed outward against the cutting edge 8.4 by the rotating rotor 5 and the blades 6, thereby further supporting the cutting or comminuting of the material.

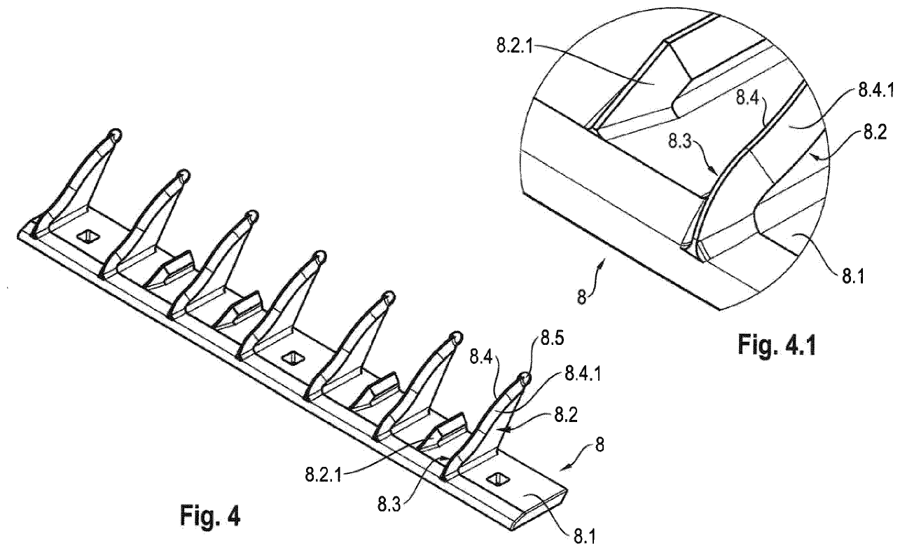

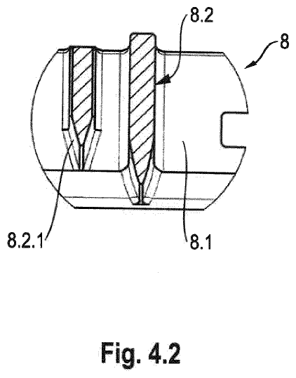

FIGS. 4 to 4.2 show an example of a cutting unit 8 with additional cutting elements 8.2.1, reduced both in their longitudinal direction and in their height, between the actual cutting elements or basic cutting elements 8.2. This achieves a better distribution and also collection of all biocomponents, including small ones, of the biomass to be comminuted.

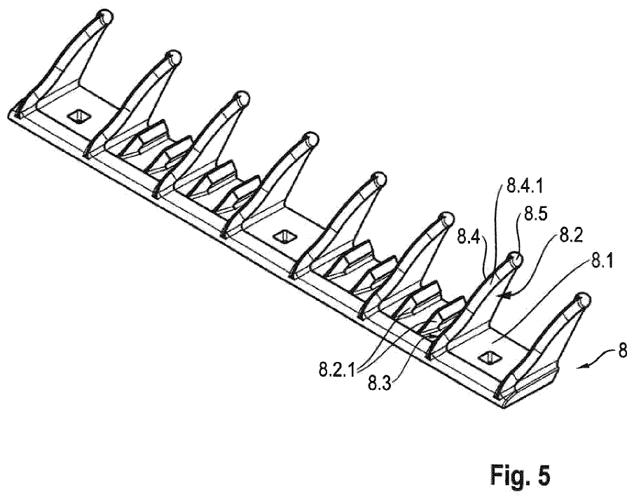

FIG. 5 shows an example of a cutting unit 8 corresponding to that of FIG. 4, with two additional cutting elements 8.2.1, rather than one additional cutting element, being arranged between two basic cutting elements 8.2.

This further improves the effect described above.

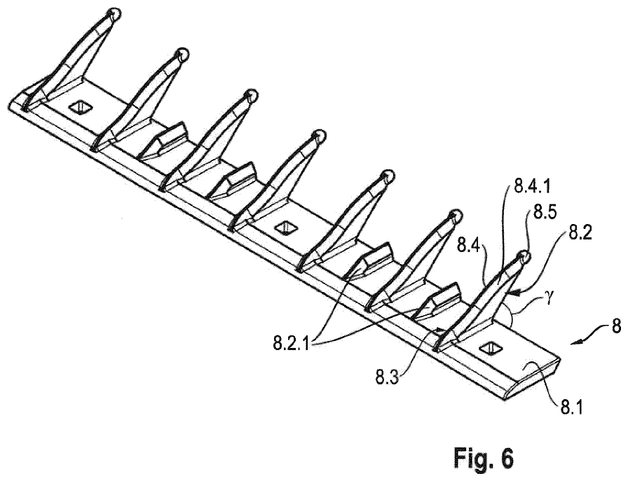

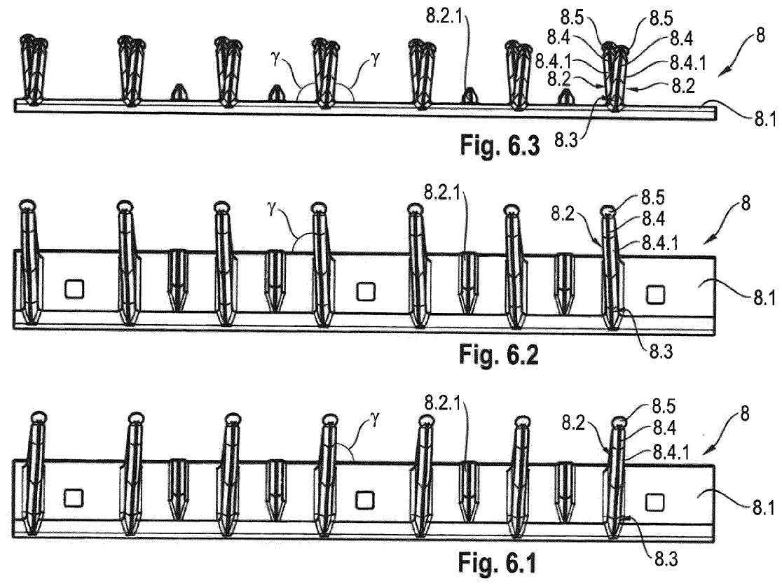

FIG. 6 is a perspective view of a cutting unit 8 in which the cutting elements, in particular the basic cutting elements 8.2, extend away from the beam 8.1 or the surface thereof at a finite angle γ not equal to 90°. In this way, in particular when the orientations of the angle γ are opposite in the case of two consecutive cutting units, as shown in FIGS. 6.1 to 6.3, a denser coverage of the two consecutive cutting elements can be achieved with overlaps in the mulching body, without a higher number of cutting elements 8.2, 8.2.1 being necessary. At the same time, the transverse distribution effect at the end of the cutting elements increases, since the rounded edges at the free ends no longer overlap but are spread out in space.

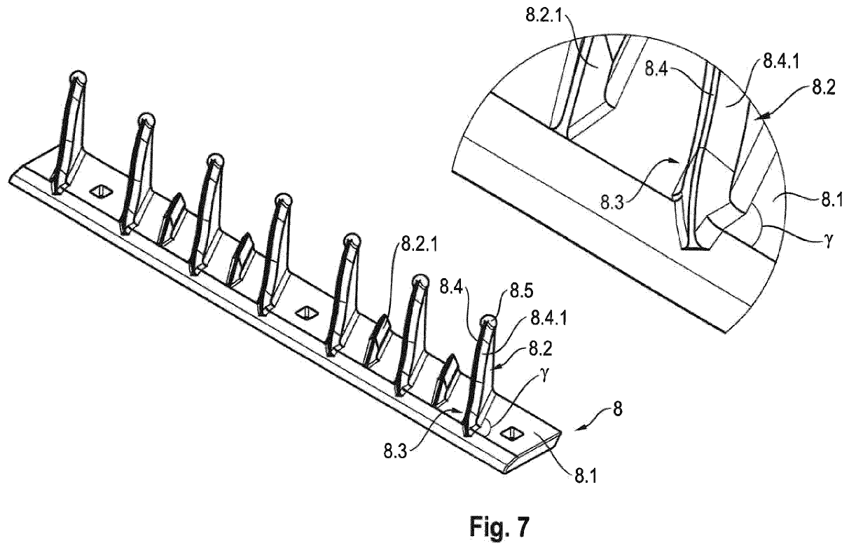

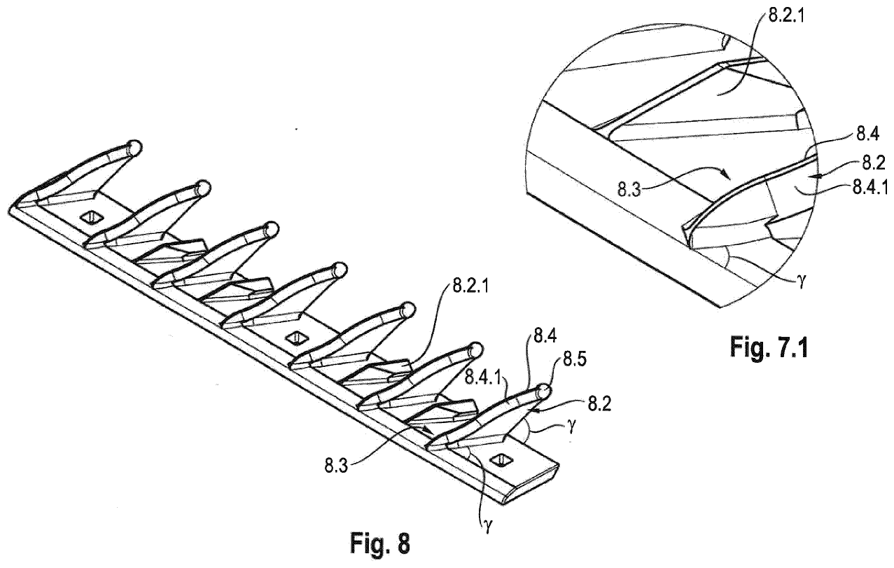

In FIG. 7, the cutting elements 8.2 and also 8.2.1 extend perpendicularly or substantially perpendicularly from the beam 8.1 or the surface thereof; but they are on the beam 8.1 at a finite angle δ not equal to 90° relative to the direction of extension or relative to the edge of the beam 8.1. This also achieves better comminution of the biomass to be comminuted by the mulching device. In particular, two cutting units according to FIG. 7 with opposite orientation of the angle δ can be arranged directly one behind the other, similar to what is shown for the embodiment of FIG. 6 in FIG. 6.3, in order to also achieve better coverage of the entire space in the horizontal extension of the obliquely arranged cutting elements for collecting, processing, and comminuting an even larger part of the biomass.

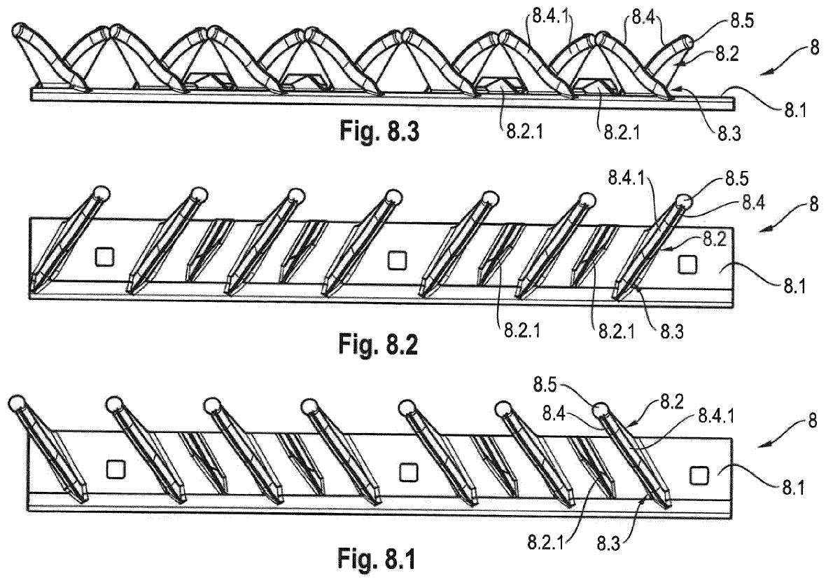

Furthermore, FIG. 8 shows a combination of the features of FIGS. 6 to 6.3 and 7, in which the cutting elements 8.2, 8.2.1 are arranged at a finite angle δ not equal to 90° relative to the longitudinal extension of the beam 8.1 or the edge thereof and also extend away from the surface of the beam 8.1 at a finite angle γ not equal to 90°. In this case, too, the effect described is improved by arranging two cutting units one behind the other with different orientations, both in terms of the oblique position relative to the direction of extension of the beam 8.1 and the inclination relative to the surface thereof, as shown in FIGS. 8.1 and 8.2, and in the rotary direction with cutting units of this type arranged one behind the other, as shown in FIG. 8.3. As a result, the two advantageous effects of the embodiment in FIGS. 6 to 6.3 and 7 are combined with one another.

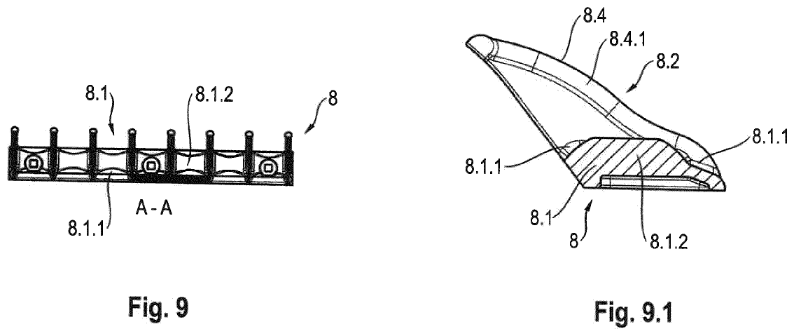

Finally, FIGS. 9 and 9.1 show a beam 8.1 of a cutting unit 1 with edge regions 8.1.1 of the longitudinal edge of the beam 8.1 that have a reduced thickness compared to a central main region 8.1.2 of the beam 8.1.

This ensures that the mulch material or the biomass does not find any edges as obstacles when it hits the cutting unit in the region of the beam and is therefore immediately guided slightly upward in order to flow away effectively, so that possible accumulation effects are avoided.

All of these examples may be difficult or impossible to achieve using conventional connections, such as bonded connections, but they can be achieved using a connection-free one-piece embodiment as a forged part or as a generatively or additively manufactured part of the entire cutting unit 8.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A mulching device comprising:
a rotor adapted to be rotated about an axis of rotation in a direction of rotation, the rotor having movable blades; and
counter-cutting elements of a cutting unit that are fixed to the device and that extend substantially perpendicularly to the axis of rotation and face the movable blades,
wherein cutting edges of the counter-cutting elements that run substantially perpendicularly to the axis of rotation and are directed opposite to the direction of rotation have a corrugated shape in their direction of extension.

2. The mulching device according to claim 1, wherein the cutting unit is formed in one piece without any connection.

3. The mulching device according to claim 1, wherein, in their direction of extension, the cutting edges of the counter-cutting elements have at least one convex and one concave portion or at least two convex portions with one concave portion arranged therebetween.

4. The mulching device according to claim 1, wherein the cutting edges are triangular in cross section.

5. The mulching device according to claim 1, wherein the cutting edges run into a sharp edge in the transverse direction relative to the longitudinal extension of the counter-cutting elements.

6. The mulching device according to claim 4, wherein faces forming the cutting edge enclose an angle of less than 90° or less than 60°.

7. The mulching device according to claim 1, wherein the counter-cutting elements have a thickening at their free end.

8. The mulching device according to claim 7, wherein the thickening is designed to be at least partially spherical.

9. The mulching device according to claim 7, wherein the counter-cutting element and the thickening are formed in one piece and/or as a forged part.

10. The mulching device according to claim 1, wherein a plurality of counter-cutting elements are formed on a crossbeam and form a cutting unit therewith.

11. The mulching device according to claim 10, wherein the counter-cutting elements are formed in one piece with the crossbeam.

12. The mulching device according to claim 10, wherein the entire cutting unit is a forged part or else a generatively or additively manufactured part.

13. The mulching device according to claim 1, wherein the radially inner end of the counter-cutting elements is arranged radially outside the outer end of the blades of the rotor.

14. The mulching device according to claim 1, wherein the cutting edges of the counter-cutting elements have a finite angle to an extension of a radius extending from the working shaft in the rotary direction of the working shaft.

15. The mulching device according to claim 1, wherein additional cutting elements have different lengths, heights, and/or thicknesses.

16. The mulching device according to claim 1, wherein at least one or two additional cutting elements have a reduced length and/or height compared to the basic cutting elements and are arranged between basic cutting elements as counter-cutting elements.

17. The mulching device according to claim 1, wherein the counter-cutting elements are aligned at right angles or at a finite angle not equal to 90° relative to an edge of the beam.

18. The mulching device according to claim 1, wherein the counter-cutting elements extend substantially perpendicularly from the beam or at a finite angle not equal to 90° from the beam.

19. The mulching device according to claim 17, wherein an alignment of the counter-cutting elements of two successive cutting units takes place at different or opposite, angles (γ) and/or (δ).

20. The mulching device according to claim 1, wherein, in a region of at least one of the longitudinal edges thereof, the beam is designed with a reduced thickness compared to a central main region thereof.
